(19) United States
(12) Patent Application Publication
(10) Pub. No.: US 2015/0170253 A1
(43) Pub. Date: Jun. 18, 2015

(54) SYSTEM AND METHOD OF RECOMMENDING TYPE OF VEHICLE BASED ON CUSTOMER USE INFORMATION AND VEHICLE STATE

(71) Applicant: Hyundai Motor Company, Seoul (KR)

(72) Inventors: Seon Su KIM, Seongnam-Si (KR); Seung-Chang PARK, Seoul (KR)

(21) Appl. No.: 14/447,055

(22) Filed: Jul. 30, 2014

(30) Foreign Application Priority Data
Dec. 17, 2013 (KR) 10-2013-0157582

(51) Int. Cl. G06Q 30/06

(52) U.S. Cl. CPC G06Q 30/0631

(57) ABSTRACT

A server receives customer information and driving information about a vehicle and accumulates and stores the received customer information and driving information in a database when driving of the vehicle ends. The server calculates a statistical average value of the driving information about the customer stored in the database based on the customer information and the vehicle information, compares the statistical average value of the driving information about the customer and a statistical average value of driving information about a plurality of general customers, and calculates a customer driving index for each item as a normal distribution based probability value. A customer tendency index is generated by multiplying a weight and the customer driving index of each item and adding the values.

### CROSS-REFERENCE TO RELATED APPLICATION

This application claims priority to and the benefit of Korean Patent Application No. 10-2013-0157582 filed in the Korean Intellectual Property Office on Dec. 17, 2013, the entire contents of which are incorporated herein by reference.

### BACKGROUND OF THE DISCLOSURE

(a) Field of the Disclosure

The present disclosure relates to a system and a method of recommending a type of vehicle, and more particularly, to a system and a method of recommending a type of vehicle based on customer use information and a vehicle state.

(b) Description of the Related Art

Recently, various electronic devices which can perform optional functions are mounted inside a vehicle for the convenience of a passenger, whose performance or available options are considerably different depending on the type of vehicle. Before purchasing a vehicle, a purchaser investigates functions, cost, or available option(s) of a vehicle one by one.

Further, various useful functions have recently been made available in a vehicle, but drivers need to check whether a corresponding function is available one by one, and investigate all of the vehicles, so that much time is required so as to be inconvenient.

In the meantime, a driving pattern and a used optional function depend on the driver so that they can be different, and a corresponding function can be applied differently according to a type or model of vehicle.

Accordingly, it is necessary for a manufacturing company to recommend vehicles corresponding to driving patterns of the drivers or optional functions used by the drivers so as to improve convenience for the drivers.

As related art relevant to recommendation of a vehicle, a technology for enabling a customer to purchase a vehicle without a separate financial loan is disclosed in Korean Patent Application Publication No. 2013-0016178.

However, the related art only provides a customer with convenience in receiving a loan when purchasing a vehicle, but a manufacturing company fails to recommend a vehicle corresponding to driving patterns of the drivers or optional functions used by the drivers.

The above information is only to enhance understanding of the background of the disclosure, and therefore it may contain information that does not constitute prior art to the present disclosure.

### SUMMARY OF THE DISCLOSURE

The present disclosure has been made in an effort to provide a system and a method of recommending a type of vehicle appropriate to a driving pattern of a customer by analyzing the driving pattern of the customer, so that a driver may receive a recommendation of a vehicle appropriate to his/her driving pattern, thereby reducing wasted time and enabling selection of a type and a model of vehicle appropriate to the driver; and a manufacturing company may recommend the type and model up to an option of a vehicle, thereby further improving the business.

Further, the present disclosure has been made in an effort to provide a system and a method of recommending a type of vehicle, in which a vehicle maker recommends to a driver a vehicle corresponding to a driving pattern of the driver or an optional function used by the driver, thereby improving recognition of the vehicle maker as a vehicle maker who considers the unique needs of each driver.

An exemplary embodiment of the present disclosure provides a method of recommending a type of vehicle, including:

receiving, by a server, customer information and driving information about a vehicle when driving of the vehicle ends;

accumulating, by the server, the driving information collected from the vehicle and storing the accumulated driving information in a database;

calculating, by the server, a statistical average value of the driving information about the customer stored in the database based on the customer information and the vehicle information, inquiring the stored statistical average value of the driving information about the customer, comparing the statistical average value of the driving information about the customer and a statistical average value of driving information about a plurality of general customers, and calculating a customer driving index for each item as a normal distribution based probability value; and

generating a customer tendency index by multiplying a weight and the customer driving index of each item and adding the values.

The weight for each item of the customer driving index may be predetermined for each item of the customer tendency index.

The customer driving index may be a value expressed by an index for at least one item among a driving section, a driving frequency, a driving time zone, a driving time, a driving distance, an average speed, an average deceleration speed, an average acceleration speed, an idle time, an average fuel efficiency, an ADAS operation history, and a safety device operation history.

The customer tendency index may include at least one item among a speed tendency index, an acceleration/deceleration index, a speed index compared to an accelerator opening rate, an acceleration/deceleration index compared to an accelerator opening rate, a weekend/weekday index, a mountain/downtown index, a fuel efficiency index, an average safety device operation index of entire sections, an average safety device operation index of a dangerous section, and an Advanced Driver Assistance System (ADAS) operation index (e.g., lane departure prevention and forward collision warning).

The method may further include

calculating a difference by comparing the calculated customer tendency index of each item and the customer tendency index of each item for each type of vehicle, and adding the difference to recommend a type of vehicle having the smallest sum value of the differences.

The method may further include

providing at least one among a predetermined web page, a mobile device of a customer, a terminal of a driver, a terminal of a charger in business of a company, and a terminal of a dealer with generated vehicle recommendation information.

Another exemplary embodiment of the present disclosure provides a system for recommending a type of vehicle communicating with a terminal of a vehicle, including:

a database which stores driving tendency information about a customer and driving tendency information for each type of vehicle; and

a server which receives customer information and driving information about the vehicle from a terminal of the vehicle when driving of the vehicle ends and stores the received customer information and driving information about the vehicle in the database, generates driving tendency information about the customer by using the driving information, and recommends a type of vehicle.

The server may include:

an information receiver which receives the driving information collected from the vehicle and stores the received driving information in the database;

a customer tendency index calculator which calculates a statistical average value of the driving information about the customer stored in the database based on the customer information and the vehicle information, compares a statistical average value of the driving information about the customer and a statistical average value of driving information about a plurality of general customers and calculates a customer driving index for each item as a normal distribution based probability value, and generates a customer tendency index by multiplying a weight and the customer driving index of each item and adding the values; and

a vehicle type recommender which calculates a difference by comparing the calculated customer tendency index of each item and the customer tendency index of each item for each type of vehicle, and adds the difference to recommend a type of vehicle having the smallest sum value of the differences.

According to the exemplary embodiments of the present disclosure, it is possible to recommend the type of vehicle appropriate to a driving pattern of a customer by analyzing the driving pattern of the customer, so that a driver may receive a recommendation of a vehicle appropriate to his/her driving pattern, thereby reducing a waste of time and enabling selection of the type and model of the vehicle appropriate to the driver, and a manufacturing company may recommend the type and model up to an option of a vehicle, thereby further improving a capability of business.

Further, according to the exemplary embodiments of the present disclosure, a vehicle maker may recommend a vehicle corresponding to a driving pattern of a driver or an optional function used by the driver, thereby improving recognition of the vehicle maker as a vehicle maker who considers driver preferences/needs.

### BRIEF DESCRIPTION OF THE DRAWINGS

FIG. 1 is a diagram illustrating a vehicle type recommendation system according to an exemplary embodiment of the present disclosure.

FIG. 2 is a flowchart illustrating an operation of a vehicle type recommendation method according to an exemplary embodiment of the present disclosure.

FIG. 3 is a table illustrating examples of driving information of the vehicle type recommendation system according to the exemplary embodiment of the present disclosure.

FIG. 4 is a graph illustrating an example of distribution of a standard deviation of driving information of the vehicle type recommendation system according to the exemplary embodiment of the present disclosure.

FIG. 5 is a table illustrating examples of a weight of a customer driving index being used to calculate a customer tendency index of the vehicle type recommendation system according to the exemplary embodiment of the present disclosure.

FIG. 6 is a table illustrating examples of a value of a customer tendency index of the vehicle type recommendation system according to the exemplary embodiment of the present disclosure.

FIG. 7 is a table illustrating examples of a calculation of a difference between a customer tendency index for each type of vehicle and a customer tendency index of a corresponding customer in the vehicle type recommendation system according to the exemplary embodiment of the present disclosure.

### DETAILED DESCRIPTION OF EXEMPLARY EMBODIMENTS

Hereinafter, exemplary embodiments of the present disclosure will be described in detail with reference to the accompanying drawings.

As those skilled in the art would realize, the described exemplary embodiments may be modified in various different ways, all without departing from the spirit or scope of the present disclosure.

In addition, each configuration illustrated in the drawings is arbitrarily shown for convenience of a description, but the present disclosure is not limited thereto.

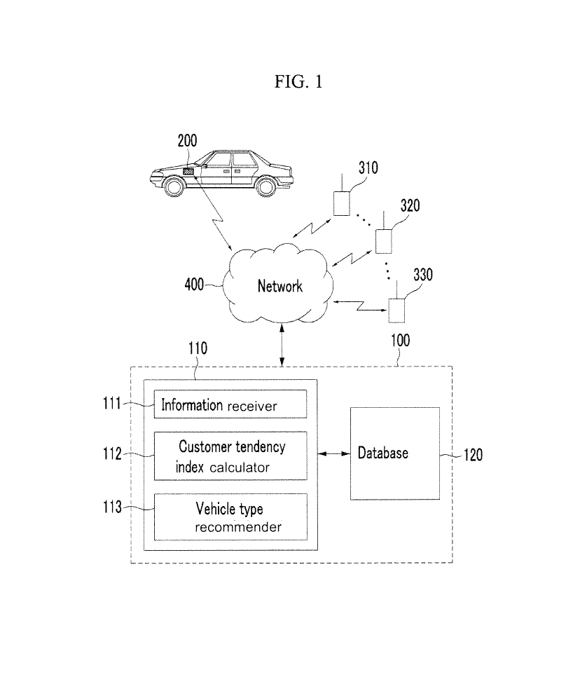

FIG. 1 is a diagram illustrating a vehicle type recommendation system according to an exemplary embodiment of the present disclosure.

Referring to FIG. 1, a vehicle type recommendation system according to an exemplary embodiment of the present disclosure embodies

a vehicle type recommendation system 100 communicating with a terminal 200 of a vehicle, and includes:

a database 120 which stores driving tendency information about a customer and driving tendency information for each type of vehicle;

and a server 110 which receives customer information and driving information about the vehicle from the terminal 200 of the vehicle when driving of the vehicle ends, stores the received customer information and driving information in the database 120, generates driving tendency information about the customer by using the driving information, and recommends a type of vehicle.

The database 120 stores a customer tendency index which is pre-determined or autonomously calculated by a manufacturing company for each type of vehicle. Further, the database 120 additionally stores a weight for each item of a customer driving index for determining a customer tendency index, from the vehicle driving information, about an individual customer and the like, as necessary. The customer driving index is a value expressed by an index for at least one item among the following: a driving section, a driving frequency, a driving time zone, a driving time, a driving distance, an average speed, an average deceleration speed, an average acceleration speed, an idle time, an average fuel efficiency, an ADAS operation history, and a safety device operation history.

Further, the customer tendency index includes at least one item among the following: a speed tendency index, an acceleration/deceleration index, a speed index compared to an accelerator opening rate, an acceleration/deceleration index compared to an accelerator opening rate, a weekend/weekday index, a mountain/downtown index, a fuel efficiency index, an average safety device operation index of entire sections, an average safety device operation index of a dangerous section, and an ADAS operation index (e.g., lane departure prevention and forward collision warning).

The server 110 includes an information receiver 111, a customer tendency index calculator 112, and a vehicle type recommender 113.

The information receiver 111 stores driving information collected from the terminal 200 of the vehicle in the database 120.

The customer tendency index calculator 112 calculates a statistical average value of the customer driving information stored in the database 120 based on the customer information and the vehicle information, compares the statistical average value of the customer driving information and a statistical average value of driving information about a plurality of general customers and calculates a customer driving index for each item as a normal distribution based probability value, and generates the customer tendency index by multiplying the customer driving index for each item by a weight and adding the values.

The vehicle type recommender 113 calculates a difference by comparing the calculated customer tendency index of each item and the customer tendency index of each item for each type of vehicle, and adds the difference to recommend a type of vehicle having the smallest sum value of the differences.

Further, depending on the case, a weight may be applied differently to each item of the customer tendency index, or each item may be added, deleted, or corrected, and the customer tendency index to which the changed information is reflected may be calculated and a type of vehicle may be recommended based on the customer tendency index.

An operation of the vehicle type recommendation system having the aforementioned configuration according to the exemplary embodiment of the present disclosure will be described in detail below.

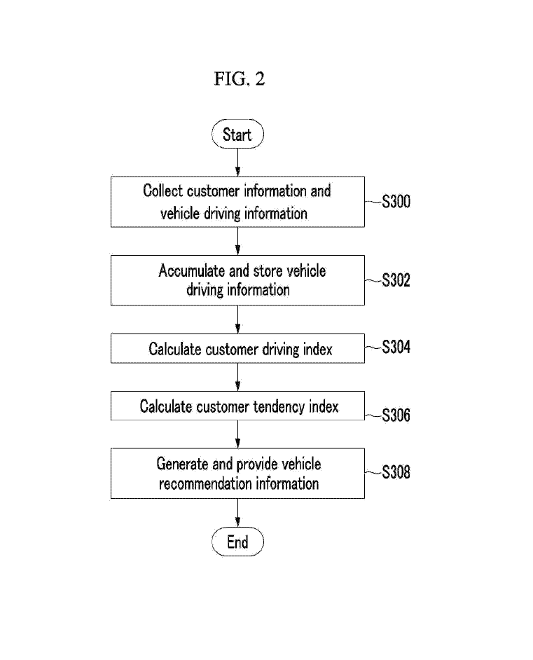

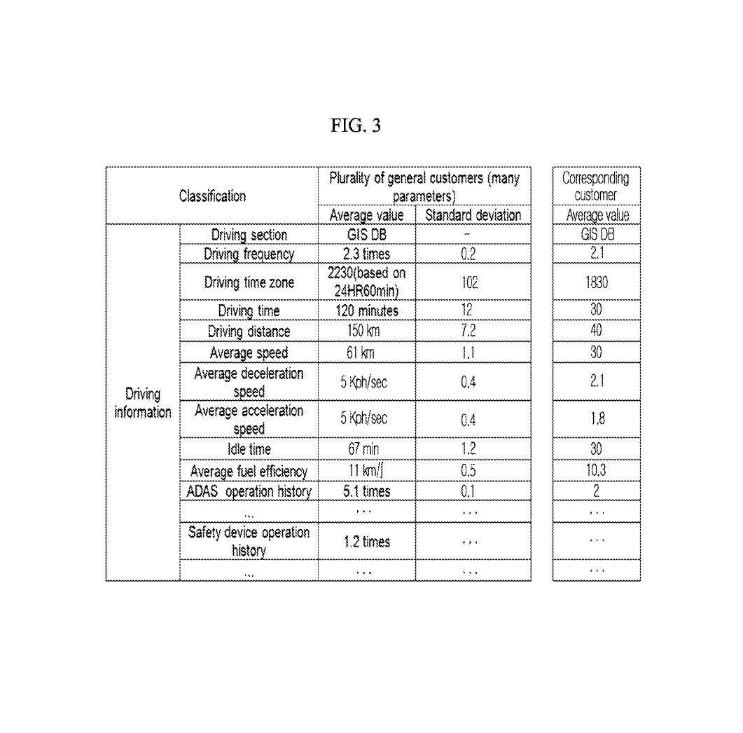

FIG. 2 is a flowchart illustrating an operation of a vehicle type recommendation method according to the exemplary embodiment of the present disclosure, and FIG. 3 is a table illustrating examples of driving information of the vehicle type recommendation system according to the exemplary embodiment of the present disclosure.

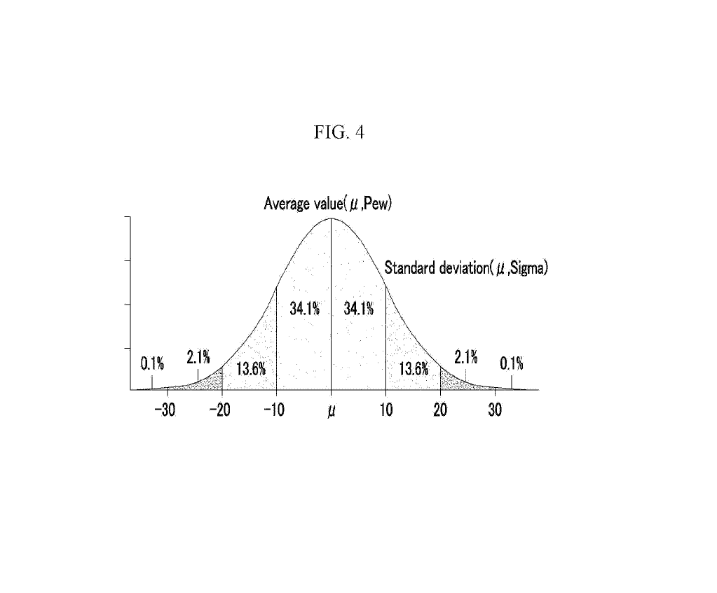

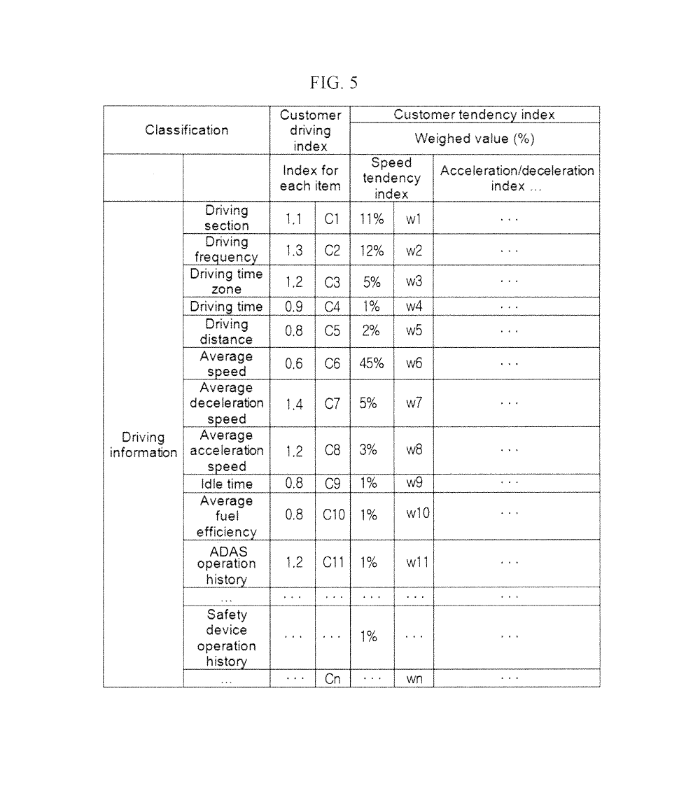

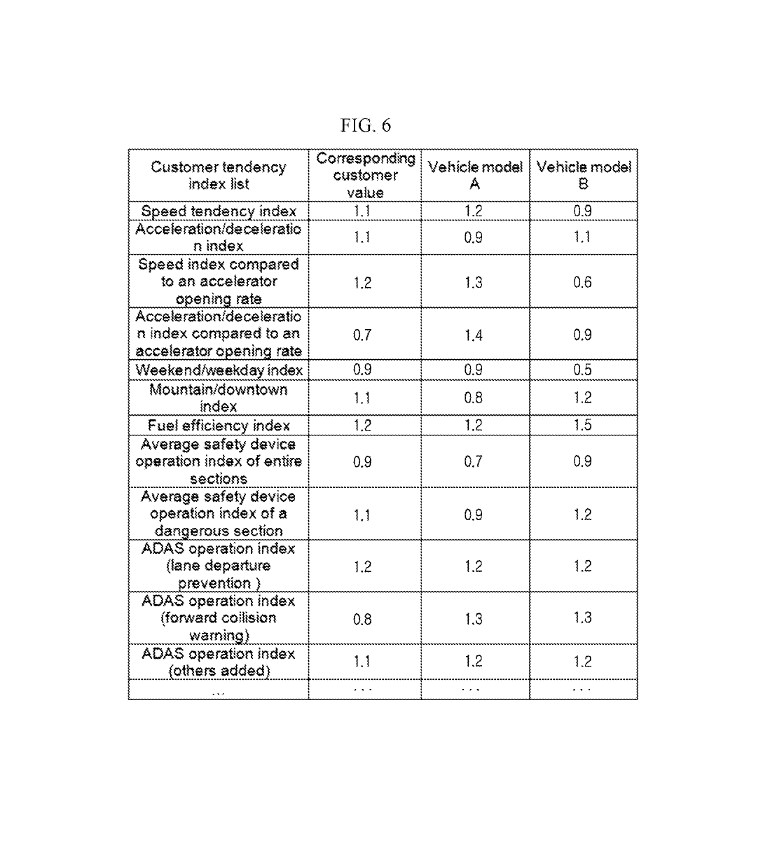

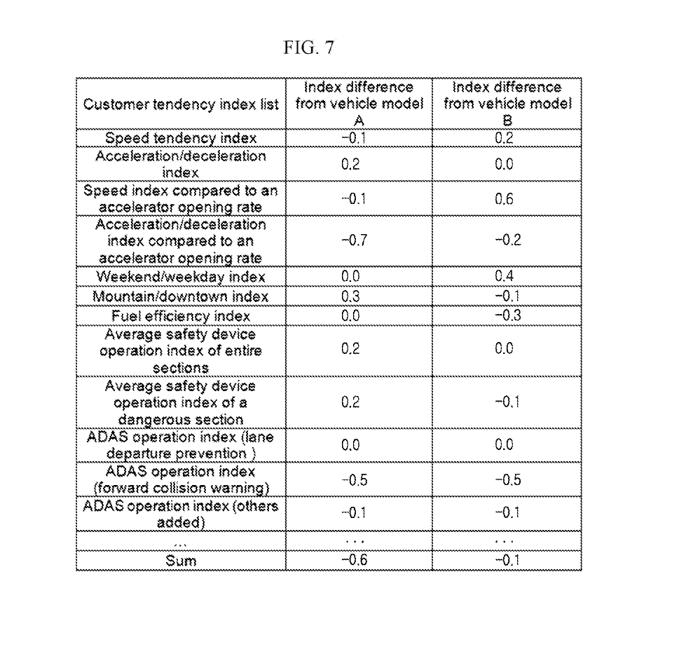

FIG. 4 is a graph illustrating an example of distribution of a standard deviation of driving information of the vehicle type recommendation system according to the exemplary embodiment of the present disclosure, FIG. 5 is a table illustrating examples of a weight of the customer driving index being used to calculate the customer tendency index of the vehicle type recommendation system according to the exemplary embodiment of the present disclosure, FIG. 6 is a table illustrating examples of a value of the customer tendency index of the vehicle type recommendation system according to the exemplary embodiment of the present disclosure, and FIG. 7 is a table illustrating examples of a calculation of a difference between the customer tendency index for each type of vehicle and the customer tendency index of a corresponding customer in the vehicle type recommendation system according to the exemplary embodiment of the present disclosure.

Referring to FIG. 2, when driving of a vehicle of an individual customer ends, the terminal 200 of the vehicle transmits customer information and driving information to a central server 110. Here, the terminal 200 may have a wireless communication function, and may transmit data by at least one of various wireless protocols, such as Code Division Multiple Access (CDMA), WiFi, 3G, and 4G.

Then, the information receiver 111 of the server 110 receives the customer information and the driving information (S300).

Then, the information receiver 111 accumulates and stores the driving information collected from the vehicle in the database 120 (S302).

For example, as illustrated in FIG. 3, the information receiver 111 accumulates and stores the driving information about a corresponding customer for each item (e.g., a driving section, a driving frequency, a driving time zone, a driving time, a driving distance, an average speed, an average deceleration speed, an average acceleration speed, an idle time, an average fuel efficiency, an ADAS operation history, and a safety device operation history). Then, the information receiver 111 generates an average value by using the driving information received from plural customers as necessary, and pre-stores the generated average value in the database 120.

Then, the customer tendency index calculator 112 of the server 110 calculates a statistical average value of the customer driving information stored in the database 120 based on the customer information and the vehicle information. Then, the customer tendency index calculator 112 of the server 110 compares the statistical average value of the customer driving information and the statistical average value of the driving information of a plurality of general customers based on a probability distribution illustrated in FIG. 4, and calculates a customer driving index for each item as a normal distribution based probability value (S304).

Referring to FIG. 5, the customer driving index is calculated for each item (e.g., the driving section, the driving frequency, the driving time zone, the driving time, the driving distance, the average speed, the average deceleration speed, the average acceleration speed, the idle time, the average fuel efficiency, the ADAS operation history, and the safety device operation history) to be expressed by C1 to Cn. As an example, the customer driving index of the driving section may be 1.1, the customer driving index of the driving frequency may be 1.3, the customer driving index of the driving time zone may be 1.2, and the like. The customer driving index is calculated through a position of an average value of an item of a corresponding customer based on a statistical distribution of a corresponding item of a plurality of general customers. That is, the customer driving index is determined to have a value between 1.5 to 0.5 according to whether an average value of the customer has a higher tendency or a lower tendency than an average value of a general customer in FIG. 4 based on the distribution of 1.5 to 0.5.

The information about the statistical distribution of the plurality of general customers of each item may be pre-stored in the database 120, or received from the outside to be updated.

Then, the customer tendency index calculator 112 generates the customer tendency index for each item (e.g., a speed tendency index, an acceleration/deceleration index, a speed index compared to an accelerator opening rate, an acceleration/deceleration index compared to an accelerator opening rate, a weekend/weekday index, a mountain/downtown index, a fuel efficiency index, an average safety device operation index of entire sections, an average safety device operation index of a dangerous section, and an ADAS operation index (e.g., lane departure prevention and forward collision warning)) as a value obtained by multiplying the customer driving index for each item by a weight and adding the values (S306). Here, the weight for each item of the customer driving index is pre-determined for each item of the customer tendency index.

Referring to FIG. 5, examples are described in which, a weight of the speed tendency index may be 11% in a case of the driving section, 12% in a case of the driving frequency, 5% in a case of the driving time zone, etc., and a different weight for the acceleration/deceleration index may be assigned. A different weight for another customer tendency index may be assigned. The weight for each item may be predetermined by a manufacturing company and may be changed and added later.

A method of calculating the customer tendency index may be expressed by the simple Equation 1 below.

Customer tendency index=Σᵢ₌₁ⁿ(Ci×wi) (Equation 1)

Then, the vehicle type recommender 113 calculates a difference by comparing the calculated customer tendency index of each item and the customer tendency index of each item for each type of vehicle stored in the database 120, and adds the difference to recommend a type of vehicle having the smallest sum value of the differences (S308).

Referring to FIG. 6, the respective items of the calculated customer tendency index are indicated by 1.1, 1.1, 1.2, . . . , the respective items of the customer tendency index of the type A vehicle stored in the database 120 are indicated by 1.2, 0.9, 1.3, . . . , and the respective items of the customer tendency index of the type B vehicle are indicated by 0.9, 1.1, 0.6, . . . .

Further, an example of a difference between the calculated customer tendency index of the corresponding customer of each item and the customer tendency index for each type of vehicle of each item, and a sum of the differences, is illustrated in FIG. 7.

Referring to FIG. 7, differences between the calculated customer tendency indexes of the respective items and the customer tendency indexes of the type A vehicle of the respective items are −0.1, 0.2, −0.1, . . . , and the sum of the differences is −0.6. Then, differences between the calculated customer tendency indexes of the respective items and the customer tendency indexes of the type B vehicle of the respective items are 0.2, 0.0, 0.6, . . . , and the sum of the differences is −0.1.

Accordingly, the sum of the differences between the customer tendency indexes of the respective items and the customer tendency indexes of the type B vehicle of the respective items is small, so that the vehicle type recommender 113 recommends the type B vehicle.

Then, depending on the case, a weight may be applied differently to each item of the customer tendency index, or each item may be added, deleted, or modified; and the customer tendency index, to which the changed information is reflected, may be calculated, or a type of vehicle may be recommended based on the customer tendency index.

Further, the vehicle type recommender 113 includes at least one terminal among a predetermined web page, mobile devices of a driver, a charger in business of a company, and a customer, or terminals 310, 320, and 330 of dealers with the generated vehicle recommendation information as necessary.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

### Description of Symbols

110: Server

111: Information receiver

112: Customer tendency index calculator

113: Vehicle type recommender

120: Database

What is claimed is:

1. A method of recommending a type of vehicle, comprising:
receiving, by a server, customer information and driving information about a vehicle when driving of the vehicle ends;
accumulating, by the server, the driving information collected from the vehicle and storing the accumulated driving information in a database;
calculating, by the server, a statistical average value of the driving information about the customer stored in the database based on the customer information and the vehicle information, inquiring the stored statistical average value of the driving information about the customer, comparing the statistical average value of the driving information about the customer and a statistical average value of driving information about a plurality of general customers, and calculating a customer driving index for each item as a normal distribution based probability value; and
generating a customer tendency index by multiplying a weight and the customer driving index of each item and adding the values.

2. The method of claim 1, wherein:
the weight for each item of the customer driving index is predetermined for each item of the customer tendency index.

3. The method of claim 2, wherein:
the customer driving index is a value expressed by an index for at least one item among a driving section, a driving frequency, a driving time zone, a driving time, a driving distance, an average speed, an average deceleration speed, an average acceleration speed, an idle time, an average fuel efficiency, an ADAS operation history, and a safety device operation history.

4. The method of claim 3, wherein:
the customer tendency index includes at least one item among a speed tendency index, an acceleration/deceleration index, a speed index compared to an accelerator opening rate, an acceleration/deceleration index compared to an accelerator opening rate, a weekend/weekday index, a mountain/downtown index, a fuel efficiency index, an average safety device operation index of entire sections, an average safety device operation index of a dangerous section, and an ADAS operation index.

5. The method of claim 4, further comprising:
calculating a difference by comparing the calculated customer tendency index of each item and the customer tendency index of each item for each type of vehicle, and adding the difference to recommend a type of vehicle having the smallest sum value of the differences.

6. The method of claim 5, further comprising:
providing at least one among a predetermined web page, a mobile device of a customer, a terminal of a driver, a terminal of a charger in business of a company, and a terminal of a dealer with generated vehicle recommendation information.

7. A system for recommending a type of vehicle communicating with a terminal of a vehicle, comprising:
a database which stores driving tendency information about a customer and driving tendency information for each type of vehicle; and
a server which receives customer information and driving information about the vehicle from a terminal of the vehicle when driving of the vehicle ends and stores the received customer information and driving information about the vehicle in the database, generates driving tendency information about the customer by using the driving information, and recommends a type of vehicle.

8. The system of claim 7, wherein:
the server includes:
an information receiver which receives the driving information collected from the vehicle and stores the received driving information in the database;
a customer tendency index calculator which calculates a statistical average value of the driving information about the customer stored in the database based on the customer information and the vehicle information, compares a statistical average value of the driving information about the customer and a statistical average value of driving information about a plurality of general customers and calculates a customer driving index for each item as a normal distribution based probability value, and generates a customer tendency index by multiplying a weight and the customer driving index of each item and adding the values; and
a vehicle type recommender which calculates a difference by comparing the calculated customer tendency index of each item and the customer tendency index of each item for each type of vehicle, and adds the difference to recommend a type of vehicle having the smallest sum value of the differences.
